(19) United States
(12) Patent Application Publication
(10) Pub. No.: US 2025/0056350 A1
(43) Pub. Date: Feb. 13, 2025

(54) WIRELESS COMMUNICATION APPARATUS, WIRELESS COMMUNICATION SYSTEM AND WIRELESS COMMUNICATION METHOD

(71) Applicant: NEC Corporation, Minato-ku, Tokyo (JP)

(72) Inventors: Rintaro KATO, Tokyo (JP); Takamichi INOUE, Tokyo (JP)

(73) Assignee: NEC Corporation, Minato-ku, Tokyo (JP)

(21) Appl. No.: 18/722,043

(22) PCT Filed: Dec. 24, 2021
(86) PCT No.: PCT/JP2021/048403

§ 371 Date: Jun. 20, 2024

(51) Int. Cl. H04W 36/08; H04L 5/00; H04W 36/30; H04W 36/34

(52) U.S. Cl. CPC H04W 36/08; H04L 5/0053; H04W 36/305; H04W 36/34

(57) ABSTRACT

To make it possible to speedily detect a radio link via which communication is possible, even in a case where the quality of wireless communication abruptly varies, a selecting means (12) is configured to control a communicating means (14) such that the communicating means (14) transmits a control signal which indicates the status of a first candidate radio link via the first candidate radio link. A second selecting means (13) is configured to select a second candidate radio link from among a plurality of radio links according to at least one selected from the group consisting of whether the control signal is successfully transmitted by the communicating means (14) and the status of an acknowledgment of the control signal, the second candidate radio link being a candidate to which a switch is made from a radio link used for communication.

### TECHNICAL FIELD

The present invention relates to a wireless communication apparatus, a wireless communication system, and a wireless communication method.

### BACKGROUND ART

In recent years, a research has been underway to stabilize communication with use of a plurality of radio links. For example, Patent Literature 1 indicates that a control apparatus routes some data units of a first group of data units via a second link and routes the other data units of the first group via a first link. The control apparatus then judges whether to switch a link to be used for a second group of data units which follows the first group of data units, from the first link to the second link, on the basis of a first communication quality of the other data units and a second communication quality of the some data units that are based on feedback information.

Further, Patent Literature 2 indicates that an expected reception time at which a receiver-side routing apparatus receives a packet is calculated for each of the links which constitute a multilink, on the basis of the communication quality of a monitored link, and among the links which constitute the multilink, a link of the earliest expected reception time is judged to be a transmission link, and a packet is sent via the transmission link.

### CITATION LIST

### Patent Literature

### [Patent Literature 1]

Japanese Patent Application Publication, Tokukai, No. 2020-096276

### [Patent Literature 2]

Japanese Patent Application Publication, Tokukai, No. 2007-060494

### SUMMARY OF INVENTION

### Technical Problem

In the environment of a factory or the like in which the quality of wireless communication abruptly varies due to the operational status of a line and the movement of a robot (metal object) or the like, there is a possibility that even immediately after measurement of a wireless communication quality, wireless communication via a radio link judged to have a good communication quality becomes impossible.

According to Patent Literature 1, the communication quality of a radio link is measured by transmission of a packet. However, since a communication quality significantly fluctuates in a wireless environment in terms of time and space, with the technique disclosed in Patent Literature 1, it is impossible to detect failure occurring after communication quality measurement, and there is a possibility that a radio link cannot be used.

According to Patent Literature 2, a time of transmission from a transmitting apparatus and a time of reception by a receiving apparatus are measured to calculate the communication quality of each link. However, also with Patent Literature 2, it is impossible to detect failure occurring after communication quality measurement, and there is a possibility that after selection of a link via which a packet is transmitted, the selected link cannot be used.

An example aspect of the present invention has been made in view of the above problems, and an example object thereof is to provide a technique for making it possible to speedily detect a radio link via which communication is possible, even in a case where the quality of wireless communication abruptly varies.

### Solution to Problem

A wireless communication apparatus in accordance with an example aspect of the present invention includes: a communicating means for conducting communication with use of at least one of a plurality of radio links; a first selecting means for selecting a first candidate radio link from among the plurality of radio links according to respective communication qualities of the plurality of radio links, the first candidate radio link being a candidate to which a switch is made from a radio link used for the communication; a controlling means for controlling the communicating means such that the communicating means transmits, via the first candidate radio link, a control signal which indicates a status of the first candidate radio link; and a second selecting means for selecting a second candidate radio link from among the plurality of radio links according to at least one selected from the group consisting of whether the control signal is successfully transmitted by the communicating means and a status of an acknowledgment of the control signal, the second candidate radio link being a candidate to which a switch is made from the radio link used for the communication.

A wireless communication system in accordance with an example aspect of the present invention includes: a communicating means for conducting communication with use of at least one of a plurality of radio links; a first selecting means for selecting a first candidate radio link from among the plurality of radio links according to respective communication qualities of the plurality of radio links, the first candidate radio link being a candidate to which a switch is made from a radio link used for the communication; a controlling means for controlling the communicating means such that the communicating means transmits, via the first candidate radio link, a control signal which indicates a status of the first candidate radio link; and a second selecting means for selecting a second candidate radio link from among the plurality of radio links according to at least one selected from the group consisting of whether the control signal is successfully transmitted by the communicating means and a status of an acknowledgment of the control signal, the second candidate radio link being a candidate to which a switch is made from the radio link used for the communication.

A wireless communication method in accordance with an example aspect of the present invention includes: selecting a first candidate radio link from among a plurality of radio links according to respective communication qualities of the plurality of radio links, the first candidate radio link being a candidate to which a switch is made from a radio link used for communication; transmitting, via the first candidate radio link, a control signal which indicates a status of the first candidate radio link; and selecting a second candidate radio link from among the plurality of radio links according to at least one selected from the group consisting of whether the control signal is successfully transmitted and a status of an acknowledgment of the control signal, the second candidate radio link being a candidate to which a switch is made from the radio link used for the communication.

### Advantageous Effects of Invention

With an example aspect of the present invention, it is possible to speedily detect a radio link via which communication is possible, even in a case where the quality of wireless communication abruptly varies.

### BRIEF DESCRIPTION OF DRAWINGS

FIG. 1 is a diagram illustrating a configuration of a wireless communication apparatus in accordance with a first example embodiment of the present invention.

FIG. 2 is a flowchart illustrating a flow of a wireless communication method carried out by the wireless communication apparatus in accordance with the first example embodiment of the present invention.

FIG. 3 is a block diagram illustrating a configuration of a wireless communication system in accordance with the first example embodiment of the present invention.

FIG. 4 is a flowchart illustrating a flow of a wireless communication method carried out by the wireless communication system in accordance with the first example embodiment of the present invention.

FIG. 5 is a diagram illustrating a configuration of a wireless communication apparatus in accordance with a second example embodiment of the present invention.

FIG. 6 is a sequence diagram of a wireless communication system which includes the wireless communication apparatus in accordance with the second example embodiment of the present invention.

FIG. 7 is an explanatory diagram of an operation of the wireless communication system which includes the wireless communication apparatus in accordance with the second example embodiment of the present invention.

FIG. 8 is a block diagram illustrating a configuration of a computer which functions as the wireless communication apparatus and the wireless communication system of each of the example embodiments.

### EXAMPLE EMBODIMENTS

### First Example Embodiment

The following description will discuss a first example embodiment of the present invention in detail, with reference to the drawings. The present example embodiment is basic to example embodiments which will be described later. It should be noted that a reference sign in the drawings which is added in the following description is intended to be added to the corresponding element for convenience and by way of example for a better understanding, and is not intended to limit the present invention to example aspects illustrated in the drawings. Further, a line connecting blocks in the drawings, etc. which are referred to in the following description includes both a bidirectional line and a unidirectional line. The unidirectional line schematically represents the main flow of signals (data), and does not exclude bidirectionality. Furthermore, although each block in the drawings may be configured to have ports or interfaces at the input and output connection points thereof, the illustration of these configurations are omitted.

### Background of Present Invention

A characteristic of wireless communication is that due to temporal and spatial fluctuation of a wireless environment, fluctuation of a communication quality and failure of communication occur at higher frequencies than in wired communication. Among the causes of this characteristic is the difference between the wireless environments of both endpoints.

In addition, because detection of failure is slower in wireless communication than in wired communication, and a link breakdown is not notified or cannot be detected, a gap can be caused between the time of link status recognition and the time of information transmission. As a result, there is a possibility that information does not reaches the other node. That is, a reliable means capable of transmitting a link status is indefinite. Note that the link status (link information) is information which indicates whether a link is in a state where communication is possible via the link. For example, in a case of communication through a first wirelessly communicating section, the other end of the communication needs to form a radio link through a first wirelessly communicating section correspondingly. However, without control for notifying or matching the status of a radio link, despite a switch to a second wirelessly communicating section at one side, the other side is not notified of the switching and continues to use the first wirelessly communicating section, and as a result, wireless communication becomes impossible.

Further, since resources that can be used for wireless communication are limited compared with those for wired communication, transmitting control signals via a plurality of radio links is a waste of the band. It is therefore necessary to provide a method for quickly dealing with the mismatch in link status recognition between both endpoints and avoiding transmitting an unnecessary control signal even in a situation where a plurality of radio links are used. Examples of the method include a method of speedily finding a radio link having a greater potential for data to be transmitted, without waiting for the reception of information which indicates the detection of failure. Note that the control signal is a signal for not only notifying the other node of the status of a radio link but also indicating which radio link to use for communication.

The other equipment which conducts communication with the wireless communication apparatus in accordance with the present example embodiment receives the control signal, and switches a radio link used for the communication with the wireless communication apparatus in accordance with the present example embodiment accordingly. For example, upon reception of the control signal by the other equipment, a control function of the other equipment switches the radio link used for the communication conducted by the other equipment and the wireless communication apparatus in accordance with the present example embodiment.

<Wireless Communication Apparatus 1 in Accordance with First Example Embodiment>

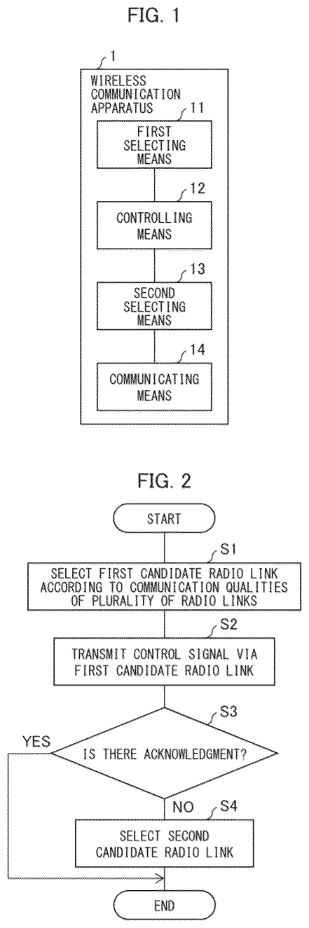

FIG. 1 is a diagram illustrating a configuration of a wireless communication apparatus 1 in accordance with the first example embodiment of the present invention. The wireless communication apparatus 1 in accordance with the present example embodiment includes a first selecting means 11, a controlling means 12, a second selecting means 13, and a communicating means 14, as illustrated in FIG. 1. The wireless communication apparatus 1 is used mainly in the environment of a factory or the like in which the quality of wireless communication abruptly varies due to the movement of a robot (metal object), etc.

The communicating means 14 uses at least one of a plurality of radio links to conduct communication. For example, the communicating means 14 is composed of a plurality of communication devices different from each other, such as WiFi (registered trademark), Bluetooth (registered trademark), and a wireless local area network (LAN). These communication devices are capable of operating independently of each other. Note that the plurality of communication devices conceptually include a plurality of RATs, and include equipment and a NIC or the like. In addition, RATs of different standards such as a wireless LAN (2.4 GHz), a wireless LAN (5 GHz), 5G, and LTE/5G shall be considered different communication devices.

The first selecting means 11 selects a first candidate radio link from among the plurality of radio links according to the respective communication qualities of the plurality of radio links, the first candidate radio link being a candidate to which a switch is made from a radio link used for the communication. The communication qualities are evaluated on the basis of, for example, received power strength, packet loss rate, upstream and downstream throughputs (maximum communication rates), round-trip time, or latency under high load. For example, in a case where quality information on the communication qualities is a packet loss rate, when the packet loss rate is lower, the quality of communication is better (higher).

The controlling means 12 controls the communicating means such that the communicating means transmits, via the first candidate radio link, a control signal which indicates the status of the first candidate radio link. As described above, the communicating means 14 is composed of a plurality of communication devices, and the controlling means 12 is capable of switching among the plurality of communication devices regarding to which communication device to input the control signal, and then causing the communication device to transmit the control signal. Similarly, the controlling means 12 is capable of switching among the plurality of communication devices regarding to which communication device to input a data signal, and then causing the communication device to transmit the data signal. The controlling means 12 is therefore even capable of inputting the data signal to a communication device which is not the communication device to which the control signal is inputted. Note that the data signal is a signal other than the signal transmitted in order to establish or switch a radio link used for communication. Examples of the signal transmitted in order to establish or switch a radio link used for communication include a signal transmitted to maintain a radio link currently in use and a control signal for notifying the status of a radio link to the other equipment.

For example, assuming that a data signal and a control signal are inputted by the controlling means 12 to a radio device of WiFi (registered trademark) which is a radio link in use, it is possible to make a switch regarding the control signal alone, to input the control signal to a radio device of a wireless LAN. In this case, it is possible to use the radio device of a wireless LAN to transmit the control signal while using the radio device of WiFi (registered trademark) to transmit the data signal.

For example, the first selecting means 11 selects, from among the plurality of radio links, a radio link having an optimum (the best) communication quality, as a new radio link (first candidate radio link). In a case where the new radio link (first candidate radio link) is not the radio link in use, the controlling means 12 then requests the communicating means 14 to transmit the control signal via the new radio link. Nevertheless, the input of the data signal to the radio link in use is maintained, and the transmission and reception of data with use of the radio link in use are ongoing.

The second selecting means 13 selects a second candidate radio link from among the plurality of radio links according to at least one selected from the group consisting of whether the control signal is successfully transmitted by the communicating means 14 and the status of an acknowledgment of the control signal, the second candidate radio link being a candidate to which a switch is made from the radio link used for communication.

The status of acknowledgment (ACK) of the control signal transmitted via the new radio link is, for example, a case of absence of an acknowledgment (ACK), and examples of the case include a case where the communicating section does not receive an acknowledgment of the control signal within a predetermined period of time. Unsuccessful transmission of the control signal via the new radio link is the case where the control signal is not transmitted to the other end of the communication for some reason, and can be measured via, for example, a network tester.

In a case of presence of an acknowledgment (ACK) from a radio link (second candidate radio link) other than the new radio link, the controlling means 12 then requests the communicating means 14 to transmit the data signal via the radio link other than the new radio link. Thus, the input of the data signal is switched by the controlling means 12 from the radio link in use to the radio link (second candidate radio link) other than the new radio link.

<Example Advantage of Wireless Communication Apparatus 1 in Accordance with First Example Embodiment>

As described above, with the wireless communication apparatus 1 in accordance with the present example embodiment, in a case of absence of an acknowledgment (ACK) of a control signal transmitted via a new radio link, the controlling means 12 requests the communicating means 14 to transmit a control signal via a radio link other than the new radio link. This enables the controlling means 12 to speedily detect a radio link via which communication is possible, even in a case where the quality of wireless communication abruptly varies.

### <Flow of Wireless Communication Method Carried Out by Wireless Communication Apparatus 1>

Here is a description of a flow of a wireless communication method carried out by the wireless communication apparatus 1 configured as described above, provided with reference to FIG. 2. FIG. 2 is a flowchart illustrating a flow of the wireless communication method carried out by the wireless communication apparatus 1 in accordance with the first example embodiment of the present invention. The wireless communication method includes steps S1 to S4, as illustrated in FIG. 2.

First, the first selecting means 11 selects a first candidate radio link from among a plurality of radio links according to the respective communication qualities of the plurality of radio links, the first candidate radio link being a candidate to which a switch is made from a radio link used for the communication (S1).

The controlling means 12 then transmits a control signal which indicates the status of the first candidate radio link via the first candidate radio link (S2).

Next, the controlling means 12 judges whether there is an acknowledgment via a new radio link (S3). According to at least one selected from the group consisting of whether the control signal is successfully transmitted and the status of an acknowledgment of the control signal, e.g., in a case of absence of an acknowledgment of the control signal (S3, No), the second selecting means 13 selects, from among the plurality of radio links, a second candidate radio link, which is a candidate to which a switch is made from the radio link used for communication (S4). In a case of presence of an acknowledgment of the control signal (S3, Yes), the process ends.

<Example Advantage of Wireless Communication Method in Accordance with First Example Embodiment>

As described above, with the wireless communication method in accordance with the present example embodiment, in a case of absence of an acknowledgment (ACK) via a new radio link, the control signal is transmitted via a radio link other than the new radio link. This makes it possible to speedily detect a radio link via which communication is possible, even in a case where the quality of wireless communication abruptly varies.

<Configuration of Wireless Communication System 100 in Accordance with First Example Embodiment>

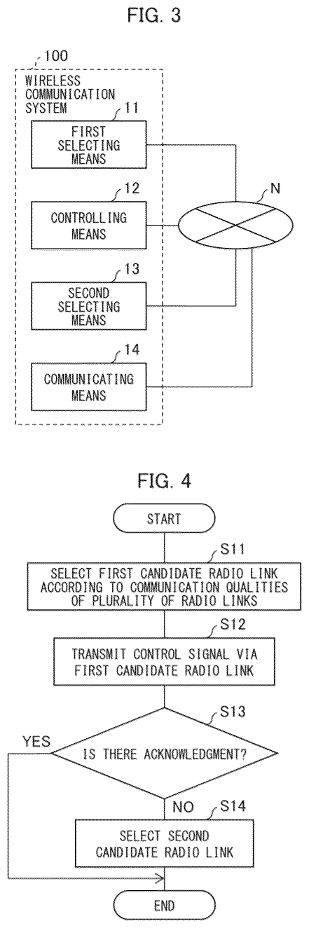

Here is a description of a configuration of a wireless communication system 100 in accordance with the present example embodiment, provided with reference to FIG. 3. FIG. 3 is a block diagram illustrating a configuration of the wireless communication system 100 in accordance with the first example embodiment of the present invention. The wireless communication system 100 includes the first selecting means 11, the controlling means 12, the second selecting means 13, and the communicating means 14, as illustrated in FIG. 3.

The first selecting means 11, the controlling means 12, the second selecting means 13, and the communicating means 14 are configured to be capable of communicating with each other, for example, via a network N. Specific examples of the network N include a wireless LAN, a wired LAN, a wide area network (WAN), a public network, a mobile data communication network, and a combination thereof, although the present example embodiment is not limited to the specific examples.

The functions of the wireless communication system 100 may be implemented on the cloud. For example, the first selecting means 11, the controlling means 12, and the second selecting means 13 may constitute one apparatus, and the communicating means 14 may constitute one apparatus. These functions may be implemented within one apparatus, or may be implemented in separate apparatuses. For example, in a case where these functions are implemented in separate apparatuses, information of each of the sections is transmitted and received via the network N to proceed with processes.

The communicating means 14 uses at least one of a plurality of radio links to conduct communication. For example, the communicating means 14 is composed of a plurality of communication devices different from each other, such as WiFi (registered trademark), Bluetooth (registered trademark), and a wireless LAN. These communication devices are capable of operating independently of each other.

The first selecting means 11 selects a first candidate radio link from among the plurality of radio links according to the respective communication qualities of the plurality of radio links, the first candidate radio link being a candidate to which a switch is made from a radio link used for the communication. The communication qualities are evaluated on the basis of, for example, received power strength, packet loss rate, upstream and downstream throughputs (maximum communication rates), round-trip time, or latency under high load.

The controlling means 12 controls the communicating means 14 such that the communicating means 14 transmits a control signal which indicates the status of the first candidate radio link via the first candidate radio link. As described above, the communicating means 14 is composed of a plurality of communication devices, and the controlling means 12 is capable of separately switching among the plurality of communication devices regarding to which communication device to input the control signal and to which communication device to input the data signal.

The second selecting means 13 selects a second candidate radio link from among the plurality of radio links according to at least one selected from the group consisting of whether the control signal is successfully transmitted by the communicating means 14 and the status of an acknowledgment of the control signal, the second candidate radio link being a candidate to which a switch is made from the radio link used for communication.

### <Flow of Wireless Communication Method Carried Out by Wireless Communication System 100>

Here is a description of a flow of a wireless communication method carried out by the wireless communication system 100 configured as described above, provided with reference to FIG. 4. FIG. 4 is a flowchart illustrating a flow of the wireless communication method carried out by the wireless communication system 100 in accordance with the first example embodiment of the present invention. The wireless communication method includes steps S11 to S14, as illustrated in FIG. 4.

First, the first selecting means 11 selects a first candidate radio link from among a plurality of radio links according to the respective communication qualities of the plurality of radio links, the first candidate radio link being a candidate to which a switch is made from a radio link used for the communication (S11).

The controlling means 12 then transmits a control signal which indicates the status of the first candidate radio link via the first candidate radio link (S12).

Next, the controlling means 12 judges whether there is an acknowledgment via a new radio link (S3). According to at least one selected from the group consisting of whether the control signal is successfully transmitted and the status of an acknowledgment of the control signal, e.g., in a case of absence of an acknowledgment of the control signal (S13, No), the second selecting means 13 selects, from among the plurality of radio links, a second candidate radio link, which is a candidate to which a switch is made from the radio link used for communication (S14). In a case of presence of an acknowledgment of the control signal (S13, Yes), the process ends.

<Example Advantage of Wireless Communication System 100 in Accordance with First Example Embodiment>

As described above, with the wireless communication system 100 in accordance with the present example embodiment, in a case of absence of an acknowledgment (ACK) via a new radio link, the controlling means 12 requests the communicating means 14 to transmit a control signal via a radio link other than the new radio link. This enables the controlling means 12 to speedily detect a radio link via which communication is possible, even in a case where the quality of wireless communication abruptly varies.

### Second Example Embodiment

The following description will discuss a second example embodiment of the present invention in detail, with reference to the drawings. A component having the same function as a component described in the first example embodiment is assigned the same reference sign, and the description thereof is omitted where appropriate.

<Configuration of Wireless Communication Apparatus 1A in Accordance with Second Example Embodiment>

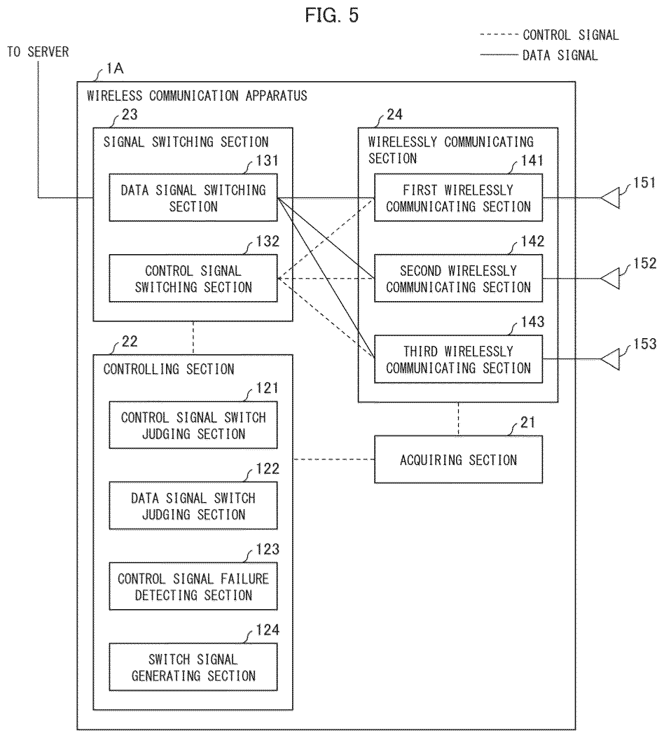

FIG. 5 is a diagram illustrating a configuration of a wireless communication apparatus 1A in accordance with the second example embodiment of the present invention. The wireless communication apparatus 1A in accordance with the present example embodiment includes an acquiring section 21, a controlling section 22, a signal switching section 23, a wirelessly communicating section 24, and antennas 151 to 153, as illustrated in FIG. 5.

The controlling section 22 is a component which implements the controlling means in the present example embodiment. The controlling section 22 and the signal switching section 23 are components which implement the first selecting means and the second selecting means in the present example embodiment. The wirelessly communicating section 24 is a component which implements the communicating means in the present example embodiment.

The wirelessly communicating section 24 includes a first wirelessly communicating section 141, a second wirelessly communicating section 142, and a third wirelessly communicating section 143. The first wirelessly communicating section 141, the second wirelessly communicating section 142, and the third wirelessly communicating section 143 are each composed of a communication device which forms a radio link. For example, the first wirelessly communicating section 141, the second wirelessly communicating section 142, and the third wirelessly communicating section 143 are composed of a plurality of communication devices different from each other, such as WiFi (registered trademark), Bluetooth (registered trademark), and a wireless LAN. To the first wirelessly communicating section 141, the second wirelessly communicating section 142, and the third wirelessly communicating section 143, antennas 151, 152, and 153 are connected, respectively.

The acquiring section 21 acquires quality information on the communication qualities of the plurality of radio links. The communication qualities are evaluated on the basis of, for example, received power strength, packet loss rate, upstream and downstream throughputs (maximum communication rates), round-trip time, or latency under high load.

The controlling section 22 includes a control signal switch judging section 121, a data signal switch judging section 122, a control signal failure detecting section 123, and a switch signal generating section 124. The signal switching section 23 includes a data signal switching section 131 and a control signal switching section 132.

The control signal switch judging section 121 refers to the quality information on the qualities of the respective radio links, which is acquired by the acquiring section 21, to judge which of the first to third wirelessly communicating sections 141 to 143 to input a control signal.

The data signal switch judging section 122 refers to the quality information on the qualities of the respective radio links, which is acquired by the acquiring section 21, to judge which of the first to third wirelessly communicating sections 141 to 143 to input a data signal.

When a control signal is transmitted from any of the first wirelessly communicating section 141, the second wirelessly communicating section 142, and the third wirelessly communicating section 143, the control signal failure detecting section 123 detects whether there is an acknowledgment (ACK) via the radio link and detects unsuccessful transmission of the control signal via the radio link.

The switch signal generating section 124 generates a switch signal for making a switch for a data signal, to output the switch signal to the data signal switching section 131. The switch signal generating section 124 generates a switch signal for making a switch for a control signal, to output the switch signal to the control signal switching section 132.

The data signal switching section 131 inputs, for example, a data signal from a server, to any of the first wirelessly communicating section 141, the second wirelessly communicating section 142, and the third wirelessly communicating section 143 according to the switch signal from the switch signal generating section 124. Note that in a case of using the wireless communication apparatus 1A as, for example, a converter for making a client-side apparatus capable of wireless communication, a communication apparatus 20 (described later) is a server-side apparatus.

The control signal switching section 132 inputs a control signal to any of the first wirelessly communicating section 141, the second wirelessly communicating section 142, and the third wirelessly communicating section 143 according to the switch signal from the switch signal generating section 124.

<Overall Flow of Processes Carried Out by Wireless Communication Apparatus 1A in Accordance with Second Example Embodiment>

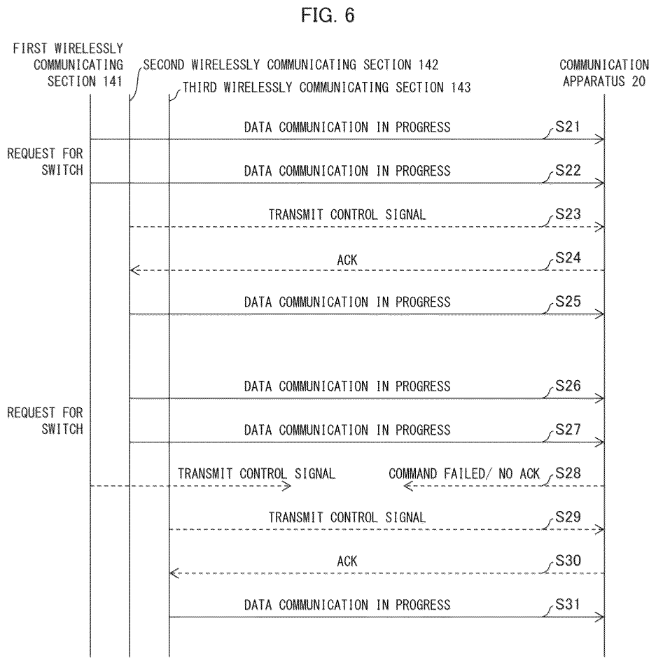

FIG. 6 is a sequence diagram of a wireless communication system which includes the wireless communication apparatus 1A in accordance with the second example embodiment of the present invention. This sequence diagram indicates the case where wireless communication is conducted between the wireless communication apparatus 1A in accordance with the present example embodiment and a communication apparatus 20 (described later).

First, a data signal from a server is inputted to the first wirelessly communicating section 141 taken as a radio link in use, and the first wirelessly communicating section 141 is conducting data communication (S21). The acquiring section 21 regularly acquires the qualities of respective radio links, to notify the qualities to the control signal switch judging section 121 and the data signal switch judging section 122.

Next, the data signal switch judging section 122 judges to which wirelessly communicating section a data signal should be inputted. The data signal switch judging section 122 judges a single optimum radio link on the basis of the quality information regarding the respective radio links. In a case where the optimum radio link is not the radio link in use, the data signal switch judging section 122 then transmits to the data signal switching section 131 a notification that a data signal is transmitted by the second wirelessly communicating section 142 via the new radio link judged. At this point, the transmission of a data signal with use of the first wirelessly communicating section 141 via the radio link in use is ongoing (S22).

The communication qualities are evaluated on the basis of, for example, received power strength, packet loss rate, upstream and downstream throughputs (maximum communication rates), round-trip time, or latency under high load. For example, in a case where the quality information is a packet loss rate, a radio link having the lowest packet loss rate is the optimum radio link.

The control signal switch judging section 121 judges via which radio link to transmit a control signal for updating the status of a radio link. In this respect, at the time when the data signal switch judging section 122 judges a switch from the radio link in use to a new radio link, the control signal switch judging section 121 requests the control signal switching section 132 to transmit a control signal through the second wirelessly communicating section 142 via the new radio link. The second wirelessly communicating section 142 transmits the control signal via the radio link (S23).

The wireless communication apparatus 1A periodically acquires and calculates the communication qualities of the plurality of radio links (e.g., two links), and takes one radio link of a better communication quality as a communication-in-progress link (Active) and takes the other as a switch candidate link (Standby). At the time when a switch of a link in use is requested and at the time of link failure, the switch candidate link (Standby) is highly likely to have a better communication quality than the communication-in-progress link (Active).

In a case where the control signal failure detecting section 123 receives an acknowledgment (ACK) from the other end of the communication (S24), the switch signal generating section 124 notifies the data signal switching section 131 of a permission for transmission and reception through the second wirelessly communicating section 142 via the new radio link, and transmits a data signal through the second wirelessly communicating section 142 via the new radio link (S25).

A data signal from a server is inputted to the second wirelessly communicating section 142 taken as a radio link in use, and the second wirelessly communicating section 142 is conducting data communication (S26). The acquiring section 21 regularly acquires the qualities of respective radio links, to notify the qualities to the control signal switch judging section 121 and the data signal switch judging section 122.

Next, the data signal switch judging section 122 judges to which wirelessly communicating section a data signal should be inputted. The data signal switch judging section 122 judges a single optimum radio link on the basis of the quality information regarding the respective radio links. In a case where the optimum radio link is not the radio link in use, the data signal switch judging section 122 then transmits to the data signal switching section 131 a notification that a data signal is transmitted by the third wirelessly communicating section 143 via the new radio link judged. At this point, the transmission of a data signal with use of the second wirelessly communicating section 142 via the radio link in use is ongoing (S27).

The control signal switch judging section 121 judges via which radio link to transmit a control signal for updating the status of a radio link. In this respect, at the time when the data signal switch judging section 122 judges a switch from the radio link in use to a new radio link, the control signal switch judging section 121 requests the control signal switching section 132 to transmit a control signal through the first wirelessly communicating section 141 via the new radio link. The first wirelessly communicating section 141 transmits the control signal via the radio link to equipment of the other end of the communication (S28).

In a case of absence of an acknowledgment (ACK) of the control signal to the first wirelessly communicating section 141 via the new radio link, or in a case of detection of unsuccessful transmission of the control signal via the new radio link, the switch signal generating section 124 requests the control signal switching section 132 to cause the third wirelessly communicating section 143 to transmit a control signal via a radio link other than the new radio link. Unsuccessful transmission of the control signal via the new radio link is the case where the control signal is not transmitted to the other end of the communication for some reason, and can be measured via, for example, a network tester.

The wirelessly communicating section 24 receives an acknowledgment of the control signal transmitted. In a case of unsuccessful transmission of the control signal by the wirelessly communicating section 24 via the first candidate radio link or absence of an acknowledgment of the control signal, in a case of presence of an acknowledgment via the second candidate radio link, the controlling section 22 controls the wirelessly communicating section 24 such that the wirelessly communicating section 24 transmits a data signal via the second candidate radio link.

Specifically, in a case of absence of an acknowledgment (ACK) from the other end of the communication to which the control signal is transmitted, or detection of unsuccessful transmission of the control signal via the new radio link (S28), the control signal failure detecting section 123 requests the control signal switch judging section 121 to transmit a control signal again. The control signal switch judging section 121 requests the control signal switching section 132 to transmit a control signal through the third wirelessly communicating section 143, which is one of the wirelessly communicating sections excluding the first wirelessly communicating section 141 (S29). The transmissions of control signals are carried out sequentially with respect to the plurality of radio links, and a radio link via which an acknowledgment (ACK) is received is taken as the radio link to be used for transmission of a data signal.

Further, the wireless communication apparatus 1A includes the control signal failure detecting section 123, which determines, according to an amount of time elapsed from when the control signal is transmitted by the wirelessly communicating section 24, the status of an acknowledgment of the control signal transmitted.

Further, in a case of unsuccessful transmission of a control signal by the wirelessly communicating section 24 via the first candidate link radio or absence of an acknowledgment of the control signal, the controlling section 22 selects, as the second candidate, a radio link via which to transmit a control signal, in descending order of the communication qualities of the radio links. For example, priorities are assigned to the plurality of radio links in descending order of the quality information on the qualities of the plurality of radio links, and a radio link assigned a higher priority is preferentially selected.

Further, in a case of unsuccessful transmission of a control signal by the wirelessly communicating section 24 via link the first candidate radio or absence an acknowledgment of the control signal, the controlling section 22 selects, as the second candidate, a radio link via which to transmit a control signal, in descending order of information on the frequencies of previous connections. For example, priorities are assigned to the plurality of radio links in descending order of the information on the frequencies of the previous connections of the respective radio links, and a radio link assigned a higher priority is preferentially selected.

In a case where the control signal failure detecting section 123 receives an acknowledgment (ACK) from the other end of the communication (S30), the switch signal generating section 124 notifies the data signal switching section 131 of a permission for transmission and reception through the third wirelessly communicating section 143 via the new radio link, and transmits a data signal through the third wirelessly communicating section 143 via the new radio link (S31).

In a case where the communication quality of the radio link used for the communication indicates radio link failure, the controlling section 22 selects the first candidate radio link and controls the wirelessly communicating section 24 such that the wirelessly communicating section 24 transmits a control signal via the first candidate radio link.

Specifically, the control signal failure detecting section 123 may be triggered by the failure (the case where the packet loss rate of the radio link in use worsens or the case of consecutive occurrences of absence of a probe response) acquired by the acquiring section 21, to notify a control signal via one of the other radio links, and take a radio link via which an acknowledgment (ACK) is received, as the radio link to be used for transmission of a data signal.

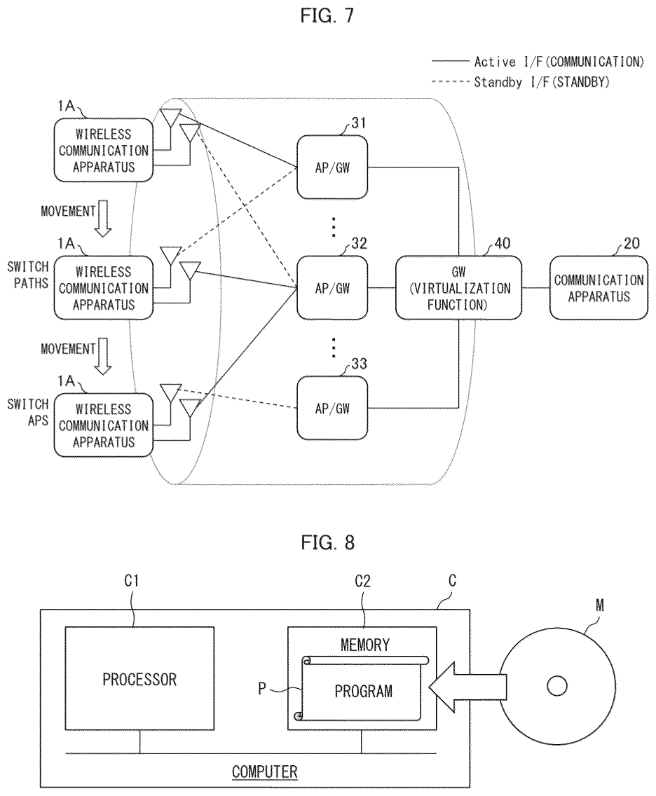

FIG. 7 is an explanatory diagram of an operation of the wireless communication system which includes the wireless communication apparatus 1A in accordance with the second example embodiment of the present invention. This wireless communication system includes the wireless communication apparatus 1A, applications/gateways (APs/GWs) 31 to 33, a GW (virtualization function) 40, and a communication apparatus 20. Note that the GW (virtualization function) 40 may be included in any of the APs/GWs 31 to 33.

The APs/GWs 31 to 33 are each a mechanism for performing, on behalf of an application used by a LAN-side computer, the operation of the application, to relay communication to an internet-side server. It should be noted that, as described above, the wireless communication apparatus 1A can be disposed on either of the server and client sides, and is therefore not limited to such a mechanism.

The wireless communication system has a configuration in which a plurality of radio links are formed by the APs/GWs 31 to 33 and the plurality of radio links are brought together by the GW (virtualization function) 40. In FIG. 7, the wireless communication apparatus 1A conducts communication while switching, according to the movement thereof, APs/GWs through which wireless communication is conducted.

As illustrated in the upper left part of FIG. 7, one of the wirelessly communicating sections of the wireless communication apparatus 1A is conducting wireless communication with the communication apparatus 20 through the AP/GW 31. Along with the movement of the wireless communication apparatus 1A, the wireless communication apparatus 1A switches between paths, so that another wirelessly communicating section conducts wireless communication with the communication apparatus 20 through the AP/GW 32, as illustrated in the middle left part of FIG. 7. Further, along with the movement of the wireless communication apparatus 1A, the wireless communication apparatus 1A switches between APs (access points), so that another wirelessly communicating section conducts wireless communication with the communication apparatus 20 through the AP/GW 32, as illustrated in the lower left part of FIG. 7.

<Example Advantage of Wireless Communication Apparatus 1A in Accordance with Second Example Embodiment>

As described above, with the wireless communication apparatus 1A in accordance with the present example embodiment, in a case of absence of an acknowledgment via a new radio link or detection of unsuccessful transmission of a control signal via the new radio link, in a case of presence of an acknowledgment via a radio link other than the new radio link, the controlling section 22 requests the signal switching section 23 to transmit a data signal via the radio link other than the new radio link. This enables the controlling section 22 to speedily detect a radio link via which communication is possible, even in a case where the quality of wireless communication abruptly varies.

Further, in a case of absence of an acknowledgment via a new radio link or detection of unsuccessful transmission of a control signal via the new radio link, the controlling section 22 maintains the transmission of a data signal via the radio link in use, and in a case of presence of an acknowledgment via a radio link other than the new radio link, the controlling section 22 requests the signal switching section 23 to transmit a data signal via the radio link other than the new radio link. This enables the controlling section 22 to, while continuing the transmission of a data signal via the radio link in use, detect a radio link via which communication is possible.

Further, in a case of absence of an acknowledgment via a new radio link or detection of unsuccessful transmission of a control signal via the new radio link, the controlling section 22 selects a radio link via which to transmit a control signal, in descending order of information on the qualities of radio links. This enables the controlling section 22 to give a higher priority to a radio link having a greater potential for communication to be conducted, to detect a radio link via which communication is possible.

Further, in a case of absence of an acknowledgment via a new radio link or detection of unsuccessful transmission of a control signal via the new radio link, the controlling section 22 selects a radio link via which to transmit a control signal, in descending order of information on the frequencies of previous connections. This enables the controlling section 22 to give a higher priority to a radio link having higher information on the frequency of the previous connections, to detect a radio link via which communication is possible.

Furthermore, in a case where information on the quality of the radio link in use indicates failure of the radio link, the controlling section 22 selects a new radio link and requests the signal switching section 23 to transmit a control signal via the new radio link. This enables the controlling section 22 to be triggered by the failure of the radio link in use, to select a new radio link.

### [Software Implementation Example]

Some or all of the functions of each of the wireless communication apparatuses 1 and 1A and the wireless communication system 100 may be implemented by hardware such as an integrated circuit (IC chip), or may be implemented by software.

In the latter case, the wireless communication apparatuses 1 and 1A and the wireless communication system 100 are each provided by, for example, a computer that executes instructions of a program that is software implementing the foregoing functions. An example (hereinafter, computer C) of such a computer is illustrated in FIG. 8. The computer C includes at least one processor C1 and at least one memory C2. The memory C2 has recorded thereon a program P for causing the computer C to operate as the wireless communication apparatuses 1 and 1A and the wireless communication system 100. The processor C1 of the computer C retrieves and executes the program P from the memory C2, so that the functions of the wireless communication apparatuses 1 and 1A and the wireless communication system 100 are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can include a flash memory, a hard disk drive (HDD), a solid state drive (SSD), and a combination thereof.

The computer C may further include a RAM into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory tangible recording medium M capable of being read by the computer C. Examples of such a recording medium M can include a tape, a disk, a card, a semiconductor memory, and a programmable logic circuit. The computer C can obtain the program P via such a recording medium M. Alternatively, the program P can be transmitted via a transmission medium. Examples of such a transmission medium can include a communication network and a broadcast wave. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the above example embodiments.

### [Additional Remark 2]

The whole or part of the example embodiments disclosed above can be described as, but not limited to, the following supplementary notes.

### (Supplementary Note 1)

A wireless communication apparatus including:
a communicating means for conducting communication with use of at least one of a plurality of radio links;
a first selecting means for selecting a first candidate radio link from among the plurality of radio links according to respective communication qualities of the plurality of radio links, the first candidate radio link being a candidate to which a switch is made from a radio link used for the communication;
a controlling means for controlling the communicating means such that the communicating means transmits, via the first candidate radio link, a control signal which indicates a status of the first candidate radio link; and
a second selecting means for selecting a second candidate radio link from among the plurality of radio links according to at least one selected from the group consisting of whether the control signal is successfully transmitted by the communicating means and a status of an acknowledgment of the control signal, the second candidate radio link being a candidate to which a switch is made from the radio link used for the communication.

This configuration enables the controlling means to speedily detect a radio link via which communication is possible, even in a case where the quality of wireless communication abruptly varies.

### (Supplementary Note 2)

The wireless communication apparatus describe in supplementary note 1, in which
the communicating means is configured to receive an acknowledgment of the control signal transmitted,
the second selecting means is configured to
   control the communicating means such that the communicating means transmits a data signal via the second candidate radio link, in a case of unsuccessful transmission of the control signal by the communicating means via the first candidate radio link or absence of an acknowledgment of the control signal, in a case of presence of an acknowledgment via the second candidate radio link.

This configuration enables the controlling means to speedily detect a radio link via which communication is possible, even in a case where the quality of wireless communication abruptly varies.

### (Supplementary Note 3)

The wireless communication apparatus described in supplementary note 1, in which
the wireless communication apparatus further includes
a determining means for determining, according to an amount of time elapsed from when the control signal is transmitted by the communicating means, a status of an acknowledgment of the control signal transmitted.

This configuration enables the determining means to easily determine the status of an acknowledgment of the control signal transmitted.

### (Supplementary Note 4)

The wireless communication apparatus described in any one of supplementary notes 1 to 3, in which
the second selecting means is configured to
select, as the second candidate radio link, a radio link via which to transmit the control signal, in descending order of the respective communication qualities of the plurality of radio links, in a case of unsuccessful transmission of the control signal by the communicating means via the first candidate radio link or absence of an acknowledgment of the control signal.

This configuration enables the second selecting means to give a higher priority to a radio link having a greater potential for communication to be conducted, to select a radio link via which communication is possible.

### (Supplementary Note 5)

The wireless communication apparatus described in any one of supplementary notes 1 to 3, in which
the second selecting means is configured to
   select, as the second candidate radio link, a radio link via which to transmit the control signal, in descending order of information on frequencies of previous connections, in a case of unsuccessful transmission of the control signal by the communicating means via the first candidate radio link or absence of an acknowledgment of the control signal.

This configuration enables the second selecting means to give a higher priority to a radio link having higher information on the frequency of the previous connections, to select a radio link via which communication is possible.

### (Supplementary Note 6)

The wireless communication apparatus described in any one of supplementary notes 1 to 5, in which
the first selecting means is configured to
   select the first candidate radio link in a case where a communication quality of the radio link used for the communication indicates radio link failure, and
the controlling means is configured to
   control the communicating means such that the communicating means transmits a control signal via the first candidate radio link.

This configuration enables the first selecting means to be triggered by failure of the radio link in use, to select a new radio link.

### (Supplementary Note 7)

A wireless communication system including:
a communicating means for conducting communication with use of at least one of a plurality of radio links;
a first selecting means for selecting a first candidate radio link from among the plurality of radio links according to respective communication qualities of the plurality of radio links, the first candidate radio link being a candidate to which a switch is made from a radio link used for the communication;
a controlling means for controlling the communicating means such that the communicating means transmits, via the first candidate radio link, a control signal which indicates a status of the first candidate radio link; and
a second selecting means for selecting a second candidate radio link from among the plurality of radio links according to at least one selected from the group consisting of whether the control signal is successfully transmitted by the communicating means and a status of an acknowledgment of the control signal, the second candidate radio link being a candidate to which a switch is made from the radio link used for the communication.

This configuration enables the controlling means to speedily detect a radio link via which communication is possible, even in a case where the quality of wireless communication abruptly varies.

### (Supplementary Note 8)

The wireless communication system described in supplementary note 7, in which
the communicating means is configured to receive an acknowledgment of the control signal transmitted,
the second selecting means is configured to
   control the communicating means such that the communicating means transmits a data signal via the second candidate radio link, in a case of unsuccessful transmission of the control signal by the communicating means via the first candidate radio link or absence of an acknowledgment of the control signal, in a case of presence of an acknowledgment via the second candidate radio link.

This configuration enables the controlling means to speedily detect a radio link via which communication is possible, even in a case where the quality of wireless communication abruptly varies.

### (Supplementary Note 9)

The wireless communication system described in supplementary note 7, in which
the wireless communication system further includes
a determining means for determining, according to an amount of time elapsed from when the control signal is transmitted by the communicating means, a status of an acknowledgment of the control signal transmitted.

This configuration enables the determining means to easily determine the status of an acknowledgment of the control signal transmitted.

### (Supplementary Note 10)

The wireless communication system described in any one of supplementary notes 7 to 9, in which
the second selecting means is configured to
   select, as the second candidate radio link, a radio link via which to transmit the control signal, in descending order of the respective communication qualities of the plurality of radio links, in a case of unsuccessful transmission of the control signal by the communicating means via the first candidate radio link or absence of an acknowledgment of the control signal.

This configuration enables the second selecting means to give a higher priority to a radio link having a greater potential for communication to be conducted, to select a radio link via which communication is possible.

### (Supplementary Note 11)

The wireless communication system described in any one of supplementary notes 7 to 9, in which
the second selecting means is configured to
   select, as the second candidate radio link, a radio link via which to transmit the control signal, in descending order of information on frequencies of previous connections, in a case of unsuccessful transmission of the control signal by the communicating means via the first candidate radio link or absence of an acknowledgment of the control signal.

This configuration enables the second selecting means to give a higher priority to a radio link having higher information on the frequency of the previous connections, to select a radio link via which communication is possible.

### (Supplementary Note 12)

The wireless communication system described in any one of supplementary notes 7 to 11, in which
the first selecting means is configured to
   select the first candidate radio link in a case where a communication quality of the radio link used for the communication indicates radio link failure, and
the controlling means is configured to
   control the communicating means such that the communicating means transmits a control signal via the first candidate radio link.

This configuration enables the first selecting means to be triggered by failure of the radio link in use, to select a new radio link.

### (Supplementary Note 13)

A wireless communication method including:
selecting a first candidate radio link from among a plurality of radio links according to respective communication qualities of the plurality of radio links, the first candidate radio link being a candidate to which a switch is made from a radio link used for communication;
transmitting, via the first candidate radio link, a control signal which indicates a status of the first candidate radio link; and
selecting a second candidate radio link from among the plurality of radio links according to at least one selected from the group consisting of whether the control signal is successfully transmitted and a status of an acknowledgment of the control signal, the second candidate radio link being a candidate to which a switch is made from the radio link used for the communication.

With this configuration, it is possible to speedily detect a radio link via which communication is possible, even in a case where the quality of wireless communication abruptly varies.

### (Supplementary Note 14)

The wireless communication method described in supplementary note 13, in which
an acknowledgment of the control signal transmitted is received, and
in a process of selecting the second candidate radio link from among the plurality of radio links,
   in a case of unsuccessful transmission of the control signal via the first candidate radio link or absence of an acknowledgment of the control signal, in a case of presence of an acknowledgment via the second candidate radio link, a data signal is transmitted via the second candidate radio link.

With this configuration, it is possible to speedily detect a radio link via which communication is possible, even in a case where the quality of wireless communication abruptly varies.

### (Supplementary Note 15)

The wireless communication method described in supplementary note 13, further including
determining, according to an amount of time elapsed from when the control signal is transmitted, a status of an acknowledgment of the control signal transmitted.

With this configuration, it is possible to easily determine the status of an acknowledgment of the control signal transmitted.

### (Supplementary Note 16)

The wireless communication method described in any one of supplementary notes 13 to 15, in which
in a process of selecting the second candidate radio link from among the plurality of radio links,
   in a case of unsuccessful transmission of the control signal via the first candidate radio link or absence of an acknowledgment of the control signal, a radio link via which to transmit the control signal is selected as the second candidate radio link, in descending order of the respective communication qualities of the plurality of radio links.

With this configuration, it is possible to give a higher priority to a radio link having a greater potential for communication to be conducted, to detect a radio link via which communication is possible.

### (Supplementary Note 17)

The wireless communication method described in any one of supplementary notes 13 to 15, in which
in a process of selecting the second candidate radio link from among the plurality of radio links,
   in a case of unsuccessful transmission of the control signal via the first candidate radio link or absence of an acknowledgment of the control signal, a radio link via which to transmit the control signal is selected as the second candidate radio link, in descending order of information on frequencies of previous connections.

With this configuration, it is possible to give a higher priority to a radio link having higher information on the frequency of the previous connections, to detect a radio link via which communication is possible.

### (Supplementary Note 18)

The wireless communication method described in any one of supplementary notes 13 to 17, in which
in a process of selecting the first candidate radio link from among the plurality of radio links,
   in a case where a communication quality of the radio link used for the communication indicates radio link failure, the first candidate radio link is selected, and
in a process of transmitting the control signal,
   a control signal is transmitted via the first candidate radio link.

With this configuration, it is possible to be triggered by failure of the radio link in use, to select a new radio link.

### (Supplementary Note 19)

A wireless communication apparatus including
at least one processor, the at least one processor carrying out:
a process of conducting communication with use of at least one of a plurality of radio links;
a process of selecting a first candidate radio link from among the plurality of radio links according to respective communication qualities of the plurality of radio links, the first candidate radio link being a candidate to which a switch is made from a radio link used for the communication;
a process of controlling the communicating means such that the communicating means transmits, via the first candidate radio link, a control signal which indicates a status of the first candidate radio link; and
a process of selecting a second candidate radio link from among the plurality of radio links according to at least one selected from the group consisting of whether the control signal is successfully transmitted by the communicating means and a status of an acknowledgment of the control signal, the second candidate radio link being a candidate to which a switch is made from the radio link used for the communication.

Note that this wireless communication apparatus may further includes a memory, and this memory may have recorded therein a program for causing the at least one processor to carry out the process of conducting communication, the process of selecting a first candidate radio link from among the plurality of radio links, the process of controlling, and the process of selecting a second candidate radio link from among the plurality of radio links. In addition, a computer-readable, non-transitory, and tangible recording medium may have this program recorded thereon.

### (Supplementary Note 20)

A wireless communication system including
at least one processor, the at least one processor carrying out:
a process of conducting communication with use of at least one of a plurality of radio links;
a process of selecting a first candidate radio link from among the plurality of radio links according to respective communication qualities of the plurality of radio links, the first candidate radio link being a candidate to which a switch is made from a radio link used for the communication;
a process of controlling the communicating means such that the communicating means transmits, via the first candidate radio link, a control signal which indicates a status of the first candidate radio link; and
a process of selecting a second candidate radio link from among the plurality of radio links according to at least one selected from the group consisting of whether the control signal is successfully transmitted by the communicating means and a status of an acknowledgment of the control signal, the second candidate radio link being a candidate to which a switch is made from the radio link used for the communication.

Note that this wireless communication system may further includes a memory, and this memory may have recorded therein a program for causing the at least one processor to carry out the process of conducting communication, the process of selecting a first candidate radio link from among the plurality of radio links, the process of controlling, and the process of selecting a second candidate radio link from among the plurality of radio links. In addition, a computer-readable, non-transitory, and tangible recording medium may have this program recorded thereon.

### REFERENCE SIGNS LIST

1, 1A: Wireless communication apparatus
11: First selecting means
12: Controlling means
13: Second selecting means
14: Communicating means
20: Communication apparatus
21: Acquiring section
22: Controlling section
23: Signal switching section
24: Wirelessly communicating section
31 to 33: AP/GW
40: GW (virtualization function)
100: Wireless communication system
121: Control signal switch judging section
122: Data signal switch judging section
123: Control signal failure detecting section
124: Switch signal generating section
131: Data signal switching section
132: Control signal switching section
141: First wirelessly communicating section
142: Second wirelessly communicating section
143: Third wirelessly communicating section
151 to 153: Antenna

What is claimed is:

1. A wireless communication apparatus comprising at least one processor, the at least one processor carrying out:
conducting communication with use of at least one of a plurality of radio links;
selecting a first candidate radio link from among the plurality of radio links according to respective communication qualities of the plurality of radio links, the first candidate radio link being a candidate to which a switch is made from a radio link used for the communication;
transmitting, via the first candidate radio link, a control signal which indicates a status of the first candidate radio link; and
selecting a second candidate radio link from among the plurality of radio links according to at least one selected from the group consisting of whether the control signal is successfully transmitted and a status of an acknowledgment of the control signal, the second candidate radio link being a candidate to which a switch is made from the radio link used for the communication.

2. The wireless communication apparatus according to claim 1, wherein
in the conducting communication, the at least one processor receives an acknowledgment of the control signal transmitted,
in the selecting a second candidate radio link from among the plurality of radio links, the at least one processor
transmits a data signal via the second candidate radio link, in a case of unsuccessful transmission of the control signal via the first candidate radio link or absence of an acknowledgment of the control signal, in a case of presence of an acknowledgment via the second candidate radio link.

3. The wireless communication apparatus according to claim 1, wherein
the at least one processor further carries out
determining, according to an amount of time elapsed from when the control signal is transmitted, a status of an acknowledgment of the control signal transmitted.

4. The wireless communication apparatus according to claim 1, wherein
in the selecting a second candidate radio link from among the plurality of radio links, the at least one processor
selects, as the second candidate radio link, a radio link via which to transmit the control signal, in descending order of the respective communication qualities of the plurality of radio links, in a case of unsuccessful transmission of the control signal via the first candidate radio link or absence of an acknowledgment of the control signal.

5. The wireless communication apparatus according to claim 1, wherein
in the selecting a second candidate radio link from among the plurality of radio links, the at least one processor
selects, as the second candidate radio link, a radio link via which to transmit the control signal, in descending order of information on frequencies of previous connections, in a case of unsuccessful transmission of the control signal via the first candidate radio link or absence of an acknowledgment of the control signal.

6. The wireless communication apparatus according to claim 1, wherein
in the selecting a first candidate radio link from among the plurality of radio links, the at least one processor
selects the first candidate radio link in a case where a communication quality of the radio link used for the communication indicates radio link failure, and
in the transmitting a control signal, the at least one processor
transmits a control signal via the first candidate radio link.

7. A wireless communication system comprising
at least one processor, the at least one processor carrying out:
conducting communication with use of at least one of a plurality of radio links;
selecting a first candidate radio link from among the plurality of radio links according to respective communication qualities of the plurality of radio links, the first candidate radio link being a candidate to which a switch is made from a radio link used for the communication;
transmitting, via the first candidate radio link, a control signal which indicates a status of the first candidate radio link; and
selecting a second candidate radio link from among the plurality of radio links according to at least one selected from the group consisting of whether the control signal is successfully transmitted and a status of an acknowledgment of the control signal, the second candidate radio link being a candidate to which a switch is made from the radio link used for the communication.

8. The wireless communication system according to claim 7, wherein in the conducting communication, the at least one processor receives, an acknowledgment of the control signal transmitted,
in the selecting a second candidate radio link from among the plurality of radio links, the at least one processor
transmits a data signal via the second candidate radio link, in a case of unsuccessful transmission of the control signal via the first candidate radio link or absence of an acknowledgment of the control signal, in a case of presence of an acknowledgment via the second candidate radio link.

9. The wireless communication system according to claim 7, wherein the at least one processor further carries out
determining, according to an amount of time elapsed from when the control signal is transmitted by the communicating means, a status of an acknowledgment of the control signal transmitted.

10. The wireless communication system according to claim 7, wherein
in the selecting a second candidate radio link from among the plurality of radio links, the at least one processor
selects, as the second candidate radio link, a radio link via which to transmit the control signal, in descending order of the respective communication qualities of the plurality of radio links, in a case of unsuccessful transmission of the control signal by the communicating means via the first candidate radio link or absence of an acknowledgment of the control signal.

11. The wireless communication system according to claim 7, wherein
in the selecting a second candidate radio link from among the plurality of radio links, the at least one processor
selects, as the second candidate radio link, a radio link via which to transmit the control signal, in descending order of information on frequencies of previous connections, in a case of unsuccessful transmission of the control signal via the first candidate radio link or absence of an acknowledgment of the control signal.

12. The wireless communication system according to claim Z, wherein
in the selecting a first candidate radio link from among the plurality of radio links, the at least one processor
selects the first candidate radio link in a case where a communication quality of the radio link used for the communication indicates radio link failure, and
in the transmitting a control signal, the at least one processor
transmits a control signal via the first candidate radio link.

13. A wireless communication method comprising:
selecting a first candidate radio link from among a plurality of radio links according to respective communication qualities of the plurality of radio links, the first candidate radio link being a candidate to which a switch is made from a radio link used for communication;
transmitting, via the first candidate radio link, a control signal which indicates a status of the first candidate radio link; and
selecting a second candidate radio link from among the plurality of radio links according to at least one selected from the group consisting of whether the control signal is successfully transmitted and a status of an acknowledgment of the control signal, the second candidate radio link being a candidate to which a switch is made from the radio link used for the communication.

14. The wireless communication method according to claim 13, wherein
an acknowledgment of the control signal transmitted is received, and
in the selecting the second candidate radio link from among the plurality of radio links,
in a case of unsuccessful transmission of the control signal via the first candidate radio link or absence of an acknowledgment of the control signal, in a case of presence of an acknowledgment via the second candidate radio link, a data signal is transmitted via the second candidate radio link.

15. The wireless communication method according to claim 13, further comprising
determining, according to an amount of time elapsed from when the control signal is transmitted, a status of an acknowledgment of the control signal transmitted.

16. The wireless communication method according to claim 13, wherein
in the selecting the second candidate radio link from among the plurality of radio links,
in a case of unsuccessful transmission of the control signal via the first candidate radio link or absence of an acknowledgment of the control signal, a radio link via which to transmit the control signal is selected as the second candidate radio link, in descending order of the respective communication qualities of the plurality of radio links.

17. The wireless communication method according to claim 13, wherein
in the selecting the second candidate radio link from among the plurality of radio links,
in a case of unsuccessful transmission of the control signal via the first candidate radio link or absence of an acknowledgment of the control signal, a radio link via which to transmit the control signal is selected as the second candidate radio link, in descending order of information on frequencies of previous connections.

18. The wireless communication method according to claim 13, wherein
in the selecting the first candidate radio link from among the plurality of radio links,
in a case where a communication quality of the radio link used for the communication indicates radio link failure, the first candidate radio link is selected, and
in the transmitting the control signal,
a control signal is transmitted via the first candidate radio link.
